(19) United States
(12) Patent Application Publication
(10) Pub. No.: US 2026/0030738 A1
(43) Pub. Date: Jan. 29, 2026

(54) DEVICE AND METHOD FOR MONITORING QUALITY CHANGES OF TEA DURING PROCESSING

(71) Applicants: JIANGSU UNIVERSITY, Zhenjiang (CN); Hunan Agricultural University, Changsha (CN)

(72) Inventors: Qin OUYANG, Zhenjiang (CN); Dengshan LI, Zhenjiang (CN); Yaqun DENG, Zhenjiang (CN); Zhonghua LIU, Changsha (CN)

(21) Appl. No.: 19/344,661

(22) Filed: Sep. 30, 2025

(30) Foreign Application Priority Data
Oct. 9, 2024 (CN) 202411401629.7

(51) Int. Cl. G06T 7/00; G06N 3/0464

(52) U.S. Cl. CPC G06T 7/0004; G06N 3/0464

(57) ABSTRACT

A device for monitoring quality changes of tea during processing, including a conveyor belt and an image acquisition device arranged thereabove. The image acquisition device includes an annular light source, a camera lens, an industrial camera, a camera mounting bracket, a camera position adjustment frame, a sliding rail, a base, a connecting screw rod and a dark box. The conveyor belt is configured to convey tea samples. The image acquisition device is configured to capture tea sample original images. A monitoring method is also provided, in which the tea sample original images are captured via the monitoring device, and preprocessed to construct a tea sample image dataset; a deformable convolutional attention-enhanced residual network (DDA-ResNet) model is trained by utilizing the tea sample image dataset; and quality indicators are accurately predicted via the trained DDA-ResNet model.

### CROSS-REFERENCE TO RELATED APPLICATIONS

This application claims the benefit of priority from Chinese Patent Application No. 202411401629.7, field on Oct. 9, 2024. The content of the aforementioned application, including any intervening amendments thereto, is incorporated by reference in its entirety.

### TECHNICAL FIELD

This application relates to non-destructive quality detection of agricultural products, and more particularly to a device and method for monitoring quality changes of tea during processing.

### BACKGROUND

Tea is very popular due to its unique color, fragrance, flavor, appearance and remarkable health benefits. Tea processing involves multiple complex steps, mainly including withering, fixation, rolling, fermentation and drying. Each step will significantly affect the tea flavor, fragrance and appearance. Monitoring the quality changes during the tea processing can help the producer timely find and correct problems during the production process, thereby ensuring tea quality stability, and maintaining the consistency of the tea flavor, fragrance and appearance. Therefore, monitoring the quality changes during the tea processing plays a key role in ensuring tea products' quality.

Traditional tea processing primarily depends on sensory evaluation results of experienced operators to adjust processing parameters. This process involves subjectivity and uncertainty, which will lead to an unstable tea quality. Moreover, conventional wet-chemistry methods or instrument methods are also adopted to determine a quality indicator, but these methods struggle with complex operation and serious time consumption, thereby failing to enable the real-time quality monitor during the tea processing.

Computer vision technology have received extensive attention in the field of the food quality monitoring during processing due to its high cost-effectiveness, fast speed, non-destructive operation and high accuracy. In the previous researches, an industrial camera is employed to capture images associated with the tea processing, including the appearance, color and texture information of tea leaves; the deep-level features are extracted from leaf images based on a deep-learning network model to establish a quality indicator prediction model, thereby determining the quality indicator level and providing technical reference for monitoring the quality changes during the tea processing. Although the computer vision technology has been reported to be used in researches about the quality indicator determination during the tea processing, it still has rarely been applied to the practical tea processing. Moreover, less attention has been paid to the development of devices and methods for monitoring the quality changes during the tea processing, which is probably caused by inconsistent lighting conditions and stacking of tea leaves on a tea production line. In addition, the appearance, color and texture features of the tea leaves undergo dynamic changes during the tea processing, such that traditional deep-learning methods involving a fixed-size convolutional kernel fail to extract the deep-level features of the dynamic changes in tea leaves, thereby limiting the improvement in the accuracy of the machine vision technology for monitoring the quality changes during the tea processing.

### SUMMARY

To solve the above problems, the present disclosure provides a device and method for monitoring quality changes of tea during processing to ensure a stable image acquisition. The deep-level features of the dynamitic changes are extracted from leaf images to establish a quality indicator prediction model, thereby achieving the accurate monitoring of the quality changes.

In order to achieve the above objects, the present disclosure adopts the following technical solutions.

The present disclosure provides a device for monitoring the quality changes of tea during processing, comprising:
a conveyor belt; and
an image acquisition device;
wherein the image acquisition device is arranged above the conveyor belt; and the image acquisition device comprises an annular light source, a camera lens, an industrial camera, a camera mounting bracket, a camera position adjustment frame, a sliding rail, a base, a connecting screw rod and a dark box;
the conveyor belt is fixed by a conveyor frame, and passing through the dark box; the base is fixed on a top of the dark box, and is fixedly connected to the sliding rail; and the camera position adjustment frame is movably arranged on the sliding rail via a slider, and is configured to slide along the sliding rail;
the camera lens is arranged on the industrial camera, and the industrial camera is arranged on the camera position adjustment frame via the camera mounting bracket; and
the annular light source is arranged below the camera lens, and the conveyor belt is arranged below the annular light source; and the dark box is configured to offer a light-free environment and ensure a consistent image acquisition condition during a tea image acquisition process.

In some embodiment, the annular light source is provided with a light-diffusing plate to scatter light beams to ensure uniform illumination on a surface of the to-be-detected tea sample; and the annular light source is fixed on the camera mounting bracket via the connecting screw rod, and is located directly below the camera lens; and the annular light source is configured to move synchronously with the industrial camera.

In some embodiment, the camera position adjustment frame comprises the slider; and the slider is arranged on the sliding rail; a first end of a first lead screw is provided at a first end of the slider, and a first end of a second lead screw is provided at a second end of the slider; a second end of the first lead screw and a second end of the second lead screw are connected to a front fixing bracket, wherein a connecting point between the first lead screw and the front fixing bracket is denoted as A point, and a connecting point between the second lead screw and the front fixing bracket is denoted as B point; a third lead screw and a fourth lead screw are provided on the front fixing bracket from the A point to the B point; the third lead screw is configured to be parallel to the fourth lead screw; the third lead screw and the fourth lead screw are movably connected to the camera mounting bracket; the camera mounting bracket is configured to move from the A point to the B point; the camera mounting bracket is connected to the industrial camera; and a vertical direction of the industrial camera is adjusted by sliding the slider.

In an embodiment, one of the first end and the second end of the slider is provided with the first adjusting knob; a horizontal movement of the first lead screw and the second lead screw is adjusted by rotating the first adjusting knob, thereby adjusting a horizontal position of the industrial camera.

In an embodiment, a second adjusting knob is provided on an end of the front fixing bracket; and the industrial camera is adjusted to move from the A point to the B point by rotating the second adjusting knob.

The present disclosure provides a method for monitoring quality changes of tea during processing, wherein the method is performed based on a monitoring device, and comprises:
step (1) capturing original images of the tea samples via the device for monitoring the quality changes of tea during processing, comprising: rotating a first adjusting knob and a second adjusting knob to adjust a horizontal position of the industrial camera and a horizontal position of the annular light source; adjusting a position of the slider on the sliding rail to ensure the industrial camera to align with the conveyor belt;
collecting H tea samples from a tea processing process, wherein His a positive integer; placing the H tea samples on the conveyor belt in sequence followed by conveying to the dark box; after the H tea samples enter the dark box, turning on the annular light source, and capturing original images of the H tea samples via the industrial camera;
step (2) preprocessing original images of the tea samples and determining the quality indicator, comprising:
delimiting a rectangular region from each of the original images of the H tea samples as a region of interest (ROI); cutting the original images of the H tea samples to obtain ROI images of the H tea samples, respectively; and constructing a tea sample image dataset X based on the ROI images of the H tea samples; and
determining a value Y of a quality indicator of the H tea samples, wherein the quality indicator comprises pigment content;
in step (2), the rectangular region has a size of 231×231 pixels, and His 500-1000;
step (3) training a deformable convolutional attention-enhanced residual network (DDA-ResNet) model with the tea sample image dataset X as input and the quality indicator as output;
wherein the DDA-ResNet model comprises an input layer, a convolutional module, a residual module, a global average pooling layer, a deformable convolutional attention module, a feature fusion module, a fully connected layer and an output layer in sequence;
a size of the input layer is identical to a size of each of the ROI images in the tea sample image dataset X, being 231×231 pixels; the convolutional module is formed by sequential connection of a first convolutional layer with a 7×7 convolution kernel, a first batch normalization layer, a first ReLU activation function layer and a first maximum pooling layer with a pooling size of 3×3;
the residual module is composed of a first residual block, a second residual block and a third residual block connected in sequence; the first residual block, the second residual block and the third residual block have the same structure, and are each composed of a second convolutional layer with a 7×7 convolution kernel, a second batch normalization layer, a second ReLU activation function layer and a second maximum pooling layer with a pooling size of 3×3 connected in sequence;
the deformable convolutional attention module is composed of a first deformable convolutional attention block, a second deformable convolutional attention block and a third deformable convolutional attention block arranged in parallel; the first deformable convolutional attention block, the second deformable convolutional attention block and the third deformable convolutional attention block have the same structure, and are each composed of a deformable convolutional sub-block and an attention sub-block connected in sequence; each of the first deformable convolutional attention block, the second deformable convolutional attention block and the third deformable convolutional attention block is configured to generate a feature map such that a total of three feature maps are generated; the feature fusion module is configured to perform pairwise fusion on the three feature maps generated by the first deformable convolutional attention block, the second deformable convolutional attention block and the third deformable convolutional attention block to form three different feature combinations; the three different feature combinations are configured to be input into the fully connected layer of the DDA-ResNet model, and mapped to the output layer of the DDA-ResNet model; and the output layer has a size of 1×1×1, and is configured to output a predicted value of the quality indicator; and
in step (3), a size of a convolution kernel of the first deformable convolutional attention block is 2×2; a size of a convolution kernel of the second deformable convolutional attention block is 4×4; and a size of a convolution kernel of the third deformable convolutional attention block is 6×6;
the DDA-ResNet model is trained through steps of:
(a) initializing network parameters of the DDA-ResNet model, and setting an initial learning rate to η and a maximum number of training iterations to N;
(b) inputting the ROI images in the tea sample image dataset X into the DDA-ResNet model, and calculating the predicted value of the quality indicator by using a forward-propagation algorithm;
(c) calculating a loss value of a loss function L according to formula (I):

$$L = \frac{{\sum }_{i = 1}^{H} {( {\hat{Y}}_{i} - {Y}_{i} )}^{2}}{H} ; \qquad ( I )$$

wherein Ŷᵢ represents a predicted value of the quality indicator of an i-th tea sample, Yᵢ represents a reference value of the quality indicator of the i-th tea sample, and H represents the number of tea samples in the tea sample image dataset X;
(d) calculating a gradient of the loss function L with respect to the network parameters of the DDA-ResNet model via a back-propagation algorithm;
(e) updating the network parameters of the DDA-ResNet model by using an Adam optimization algorithm according to the gradient; and
(f) repeating steps (b)-(e) until the loss value of the loss function L converges or the maximum number of iterations N is reached, a trained DDA-ResNet model is obtained; and
step (4) performing quality monitoring of a to-be-detected sample through steps of:
collecting the to-be-detected tea sample from the tea processing process;
obtaining an ROI image of the to-be-detected tea sample according to steps (1)-(2);
inputting the ROI image of the to-be-detected tea sample into the trained DDA-ResNet model; and
outputting, by the trained DDA-ResNet model, a quality indicator of the to-be-detected tea sample to achieve quality monitoring during the tea processing process.

The present disclosure provides an electronic device, comprising:
a memory; and
a processor;
wherein the memory is electrically connected to the processor to achieve communication; the memory is configured to store a program; and the processor is configured to execute the program stored in the memory to implement the aforementioned method.

The present disclosure provides a non-transitory computer-readable storage medium, wherein a computer program is stored in the non-transitory computer-readable storage medium, and the computer program is configured to be executed by a processor to implement the aforementioned method.

Compared to the prior art, the present disclosure has the following beneficial effects.

The present disclosure provides a device for monitoring quality changes of tea during processing, in which several mechanical elements including the sliding rail, the camera position adjustment frame and the camera mounting bracket are arranged to ensure the annular light source to be coaxial with the industrial camera in the vertical direction, such that the positions of the industrial camera and the annular light source can be synchronously adjusted in the horizontal and vertical directions according to practical need. The image acquisition device is arranged in the dark box to maintain the light-free environment. The annular light source is adopted to provide a stable light condition, thereby reducing interferences from the external factors during the tea image acquisition, enhancing the stability of the image acquisition environment during the tea processing, and improving the reliability of utilizing computer vision technology to predict the quality indicator during the tea processing process.

The present disclosure provides a DDA-ResNet model to monitor the quality changes during the tea processing, which is established through modification of the traditional ResNet model. Specifically, a dynamic deformable convolutional neural network module is introduced into the traditional ResNet model, such that the model can make adaptive adjustments according to local shape and texture of the tea leaves, thereby more precisely capturing key local features of the tea leaves related to the quality indicator. This method not only improves the flexibility of the model feature extraction, but also enhances the model's adaptability to the dynamic changes of tea leaves. In addition, the DDA-ResNet model further integrates a channel attention mechanism, which prioritizes feature channels highly correlated with the quality indicator in the tea processing, thereby improving the accuracy and generalization performance in predicting the quality indicator during processing.

### BRIEF DESCRIPTION OF THE DRAWINGS

FIG. 1 schematically shows a device for monitoring quality changes of tea during processing according to an embodiment of the present disclosure;

FIG. 2 schematically shows a camera position adjustment frame, a camera mounting bracket, a sliding rail, an industrial camera, a connecting screw rod and an annular light source according to an embodiment of the present disclosure;

FIG. 3 is a flowchart of a method for monitoring quality changes of tea during processing according to an embodiment of the present disclosure;

FIG. 4 schematically shows a DDA-ResNet model for determining quality indicator of tea during processing according to an embodiment of the present disclosure;

FIG. 5a is a scatter plot of chlorophyll a contents predicted by the DDA-ResNet model during the tea drying process;

FIG. 5b is a scatter plot of chlorophyll b contents predicted by the DDA-ResNet model during the tea drying process; and

FIG. 5c is a scatter plot of total chlorophyll contents predicted by the DDA-ResNet model during the tea drying process.

In the figures: 1—conveyor belt; 2—annular light source; 3—camera lens; 4—industrial camera; 5—camera mounting bracket; 6—camera position adjustment frame; 6.1—slider; 6.2.1—first lead screw; 6.2.2—second lead screw; 6.3—front fixing bracket; 6.4.1—third lead screw; 6.4.2—fourth lead screw; 6.5—first adjusting knob; 6.6—second adjusting knob; 7—sliding rail; 8—base; 9—connecting screw rod; and 10—dark box.

### DETAILED DESCRIPTION OF EMBODIMENTS

The present disclosure will be detailly described below with reference to the embodiments and drawings. It should be noted that these embodiments are merely illustrative, and are not intended to limit the present disclosure.

As used herein, terms are merely for the purpose of describing the embodiments, and are not intended to limit the present disclosure. Unless otherwise defined, technical or scientific terms used herein shall have the same meaning as commonly understood by those of ordinary skill in the art to which this application belongs.

It is obvious for those skilled in the art that various improvements and modifications can be made according to the embodiments of the present disclosure without departing from the scope and spirit of the present disclosure.

Obviously, other embodiments can be obtained by those skilled in the art according to the embodiments of the present disclosure, and the description and embodiments of the present disclosure are merely illustrative.

In order to make the objects, technical solutions and technical effects clearer, the present disclosure will be further described in combination with the accompanying drawings and the embodiments.

An embodiment of the present disclosure provides a device and method for monitoring quality changes during the tea drying process to predict the content of chlorophyll a, chlorophyll b and total chlorophyll during the tea drying process. Predicted values of the content of the chlorophyll a, chlorophyll b and total chlorophyll are compared with corresponding reference vales to verify the prediction accuracy of the system or the method. The embodiment is performed through the following steps.

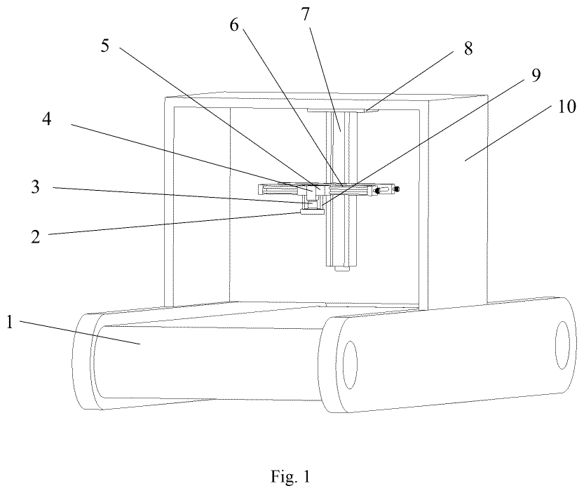

Referring to FIG. 1, the present disclosure provides the device for monitoring quality changes of tea during processing, including a conveyor belt 1 and an image acquisition device, in which the image acquisition device is arranged above the conveyor belt 1. The image acquisition device includes an annular light source 2, a camera lens 3, an industrial camera 4, a camera mounting bracket 5, a camera position adjustment frame 6, a sliding rail 7, a base 8, a connecting screw rod 9 and a dark box 10. The base 8 is fixed on a top of the dark box 10 via bolts. The conveyor belt 1 is fixed by a conveyor frame and passing through the dark box 10. The sliding rail 7 is fixed on the base 8 via blots. The camera position adjustment frame 6 is movably arranged on the sliding rail 7 via a slider. The camera lens 3 is arranged on the industrial camera 4, and the industrial camera 4 is arranged on the camera position adjustment frame 6 via the camera mounting bracket 5.

In some embodiment, the annular light source 2 is provided with a light-diffusing plate to scatter light beams to ensure uniform illumination on a surface of the to-be-detected tea sample. The annular light source 2 is fixed on the camera mounting bracket 5 via the connecting screw rod 9, and is located directly below the industrial camera 4. The annular light source 2 is configured to move synchronously with the industrial camera 4.

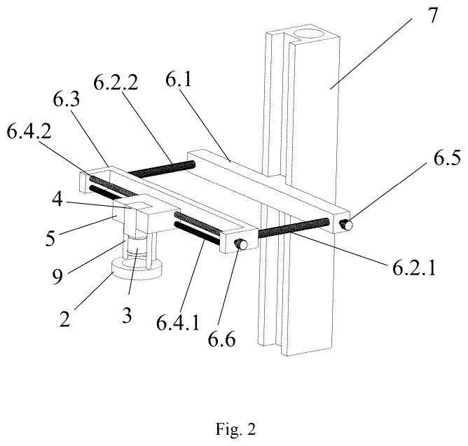

Referring to FIG. 2, the camera position adjustment frame 6 includes the slider 6.1. The slider 6.1 is arranged on the sliding rail 7. A first end of a first lead screw 6.2.1 is provided at a first end of the slider 6.1, and a first end of a second lead screw 6.2.2 is provided at a second end of the slider 6.1. A second end of the first lead screw 6.2.1 and a second end of the second lead screw 6.2.2 are connected to a front fixing bracket 6.3, where a connecting point between the first lead screw 6.2.1 and the front fixing bracket 6.3 is denoted as A point, and a connecting point between the second lead screw 6.2.2 and the front fixing bracket 6.3 is denoted as B point. A third lead screw 6.4.1 and a fourth lead screw 6.4.2 are provided on the front fixing bracket 6.3 from the A point to the B point. The third lead screw 6.4.1 and the fourth lead screw 6.4.2 are movably connected to the camera mounting bracket 5. The camera mounting bracket 5 is configured to move from the A point to the B point, and the camera mounting bracket is connected to the industrial camera 4. A vertical direction of the industrial camera 4 is adjusted by sliding the slider 6.1.

In an embodiment, one of the first end and the second end of the slider 6.1 is provided with the first adjusting knob 6.5. A horizontal movement of the first lead screw 6.2.1 and the second lead screw 6.2.2 is adjusted by rotating the first adjusting knob 6.5, thereby adjusting a horizontal position of the industrial camera 4.

In an embodiment, the second adjusting knob 6.6 is provided on an end of the front fixing bracket 6.3. The industrial camera 4 is adjusted to move from the A point to the B point by rotating the second adjusting knob 6.6.

In an embodiment, the dark box 10 is configured to offer a light-free environment and ensure a consistent image acquisition condition during a tea image acquisition process.

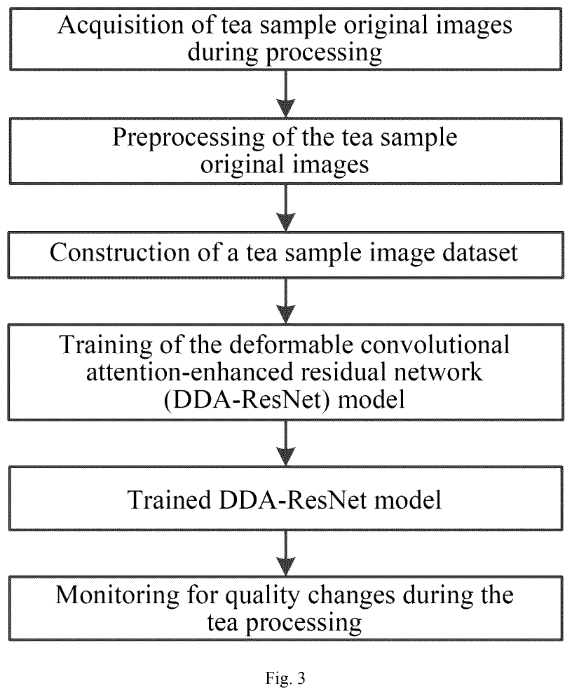

Referring to FIG. 3, a method for monitoring quality changes of tea during processing based on the aforementioned device, is performed through the following steps.

Step (1) the original images of the tea samples are captured via the device for monitoring the quality changes of tea during processing.

The first adjusting knob 6.5 and the second adjusting knob 6.6 are rotated to adjust a horizontal position of the industrial camera 4 and a horizonal position of the annular light source 2. A position of the slider 6.1 on the sliding rail 7 is adjusted to ensure the industrial camera 4 to clearly capture the original images of the tea samples.

Tea samples are taken from different drying stages in the tea drying process, placed on the conveyor belt 1 and conveyed into the dark box 10. After the tea samples entered into the dark box 10, the annular light source 2 is turned on, and the original images of the tea samples are captured via the industrial camera 4.

Step (2) the original images of the tea samples are preprocessed, and the chlorophyll content is determined.

A rectangular region of 231×231 pixels is delimited from each of the original images of the tea samples as a region of interest (ROI). The original images of the tea samples are cut to obtain ROI images of the tea samples, respectively. A tea sample image dataset X is constructed based on the 720 ROI images of the tea samples. The tea sample image dataset X is divided into a training set and a testing set according to a ratio of 9:1, where the training set includes 648 ROI images of the tea samples, and the testing set includes 72 ROI images of the tea samples.

The contents of chlorophyll a, chlorophyll b and total chlorophyll of tea samples in the training set and the testing set are determined by a spectrophotometric method, respectively.

Step (3) A deformable convolutional attention-enhanced residual network (DDA-ResNet) model is trained with the tea sample image dataset X as input and the quality indicator as output.

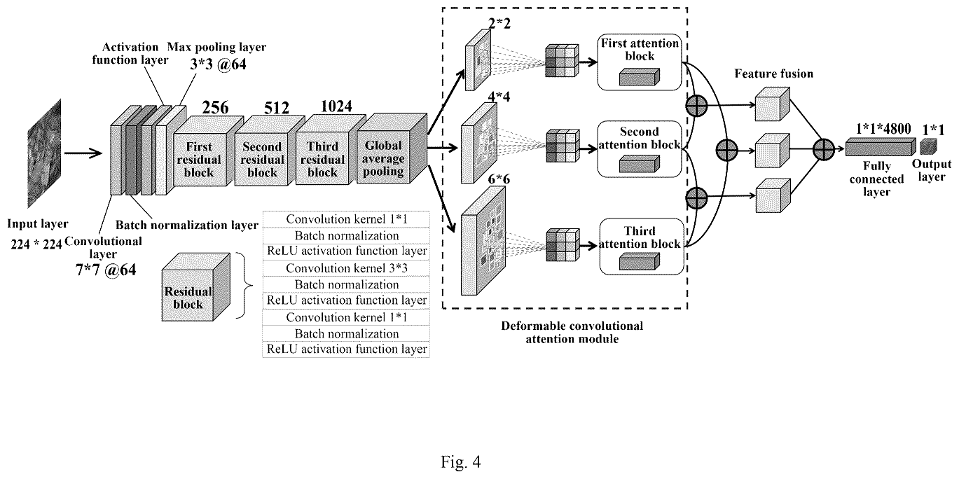

Referring to FIG. 4, the DDA-ResNet model includes an input layer, a convolutional module, a residual module, a global average pooling layer, a deformable convolutional attention module, a feature fusion module, a fully connected layer and an output layer in sequence.

A size of the input layer is identical to a size of each of the ROI images in the tea sample image dataset X, being 231×231 pixels.

The convolutional module is formed by sequential connection of a first convolutional layer with a 7×7 convolution kernel of, a first batch normalization layer, a first ReLU activation function layer and a first maximum pooling layer with a pooling size of 3×3.

The residual module is composed of a first residual block, a second residual block and a third residual block connected in sequence. The first residual block, the second residual block and the third residual block have the same structure, and are each composed of a second convolutional layer with a 7×7 convolution kernel, a second batch normalization layer, a second ReLU activation function layer and a second maximum pooling layer with a pooling size of 3×3 connected in sequence.

The deformable convolutional attention module is composed of a first deformable convolutional attention block, a second deformable convolutional attention block and a third deformable convolutional attention block arranged in parallel. The first deformable convolutional attention block, the second deformable convolutional attention block and the third deformable convolutional attention block have the same structure, and are each composed of a deformable convolutional sub-block and an attention sub-block connected in sequence. The convolution kernel of the first deformable convolutional attention block has a size of 2×2. The convolution kernel of the second deformable convolutional attention block has a size of 4×4. The convolution kernel of the third deformable convolutional attention block has a size of 6×6. Each of the first deformable convolutional attention block, the second deformable convolutional attention block and the third deformable convolutional attention block is configured to generate a feature map such that a total of three feature maps are generated.

The three feature maps generated by the first, second and third deformable convolutional attention blocks are fused in pairs via the feature fusion module to form three different feature fusions. The three different feature fusions are configured to be input into the fully connected layer of the DDA-ResNet model, and mapped to the output layer of the DDA-ResNet model via the fully connected layer.

The output layer has a size of 1×1×1, and the output layer is configured to output predicted values of chlorophyll a, chlorophyll b and total chlorophyll contents.

The DDA-ResNet model is trained through the following steps.

(a) Network parameters of the DDA-ResNet model are initialized, and an initial learning rate is set to 0.0001 and a maximum number of training iterations is set to 200.

(b) The ROI images in the training set are input into the DDA-ResNet model, and the predicted values of the contents of chlorophyll a, chlorophyll b and total chlorophyll are calculated by using a forward-propagation algorithm.

(c) A loss value of a loss function L is calculated according to formula (I):

$$L = \frac{{\sum }_{i = 1}^{H} {( {\hat{Y}}_{i} - {Y}_{i} )}^{2}}{H} ; \qquad ( I )$$

where Ŷᵢ represents a predicted value of the quality indicator of an i-th tea sample, Yᵢ represents a value of the quality indicator value of the i-th tea sample, and H represents the number of the tea samples in the tea sample image dataset X.

(d) A gradient of the loss function L with respect to the network parameters of the DDA-ResNet model is calculated via a back-propagation algorithm.

(e) The network parameters of the DDA-ResNet model are updated by using an Adam optimization algorithm according to the gradient.

(f) Steps (b)-(e) are repeated until the loss value of the loss function L converges or the maximum number of training iterations N is reached to 200, a trained DDA-ResNet model is obtained.

Step (4) the quality monitoring of a to-be-detected sample is performed.

The 72 ROI images of the tea samples in the testing set are input into the trained DDA-ResNet model to output the predicted values of chlorophyll a, chlorophyll b and total chlorophyll contents. The root mean square error and correlation coefficient between the predicted and measured values of chlorophyll a, chlorophyll b, and total chlorophyll contents are calculated to evaluate the prediction and generalization performance of the trained DDA-ResNet model.

In order to further verify the effectiveness of the DDA-ResNet model proposed herein, a ResNet-3 model, a MS-ResNet model and a DD-ResNet model were trained through the 648 ROI images of tea samples in the training set. The training parameters of the ResNet-3 model, the MS-ResNet model and the DD-ResNet model were consistent with that of the DDA-ResNet model provided herein. The prediction performances of the ResNet-3 model, the MS-ResNet model and the DD-ResNet model were proved through the 72 ROI images of tea samples in the testing set.

The following table presented the root mean square error of the training set (RMSEC), correlation coefficient of the training set (R_{c}), root mean square error of the testing set (RMSEP), and correlation coefficient of the testing set (Rp) for the ResNet-3 model, MS-ResNet model, DD-ResNet model, and the DDA-ResNet model provided herein.

TABLE 1
The performance parameters of a prediction model of chlorophyll
content in tea samples based on different deep-learning network

| | | Training set | | Testing set | |
|---|---|---|---|---|---|
| Chlorophyll | | RMSEC | | RMSEP | |
| type | Model | (mg/g) | R_{c} | (mg/g) | Rₚ |
| Chlorophyll | ResNet-3 | 0.12 | 0.9889 | 0.26 | 0.9514 |
| a | MS-ResNet | 0.21 | 0.9708 | 0.25 | 0.9601 |
| | DD-ResNet | 0.15 | 0.9886 | 0.26 | 0.9595 |
| | DDA-ResNet | 0.14 | 0.9869 | 0.22 | 0.9656 |
| Chlorophyll | ResNet-3 | 0.25 | 0.8348 | 0.29 | 0.8193 |
| b | MS-ResNet | 0.25 | 0.8846 | 0.29 | 0.8232 |
| | DD-ResNet | 0.24 | 0.8399 | 0.29 | 0.8365 |
| | DDA-ResNet | 0.28 | 0.8604 | 0.25 | 0.8640 |
| Total | ResNet-3 | 0.26 | 0.9817 | 0.52 | 0.9412 |
| chlorophyll | MS-ResNet | 0.27 | 0.9824 | 0.45 | 0.9455 |
| | DD-ResNet | 0.17 | 0.9912 | 0.42 | 0.9466 |
| | DDA-ResNet | 0.18 | 0.9883 | 0.40 | 0.9503 |

As shown in Table 1, the DDA-ResNet model proposed herein achieved a higher prediction accuracy for chlorophyll a, chlorophyll b, and total chlorophyll contents of tea samples compared to the ResNet-3, MS-ResNet, and DD-ResNet models. The DDA-ResNet proposed herein replaced fixed convolutional kernels with dynamic deformable convolutional kernels, enabling the model to adaptively adjust to local leaf shapes and textures. This replacement allowed more precise capture of key local features related to chlorophyll content of tea during processing. This method not only increased the flexibility of feature extraction but also improved the model's adaptability to dynamic changes in leaf appearance. Therefore, compared with the ResNet-3, MS-ResNet and DD-ResNet models, the performance of the DDA-ResNet model in predicting chlorophyll content has been improved. Furthermore, the DDA-ResNet model further incorporated a channel attention mechanism, which optimized information flow by prioritizing feature channels highly correlated with chlorophyll content, such as color intensity and textural details. This integration enhanced both the accuracy and generalization capability of the model in predicting chlorophyll content of tea during processing.

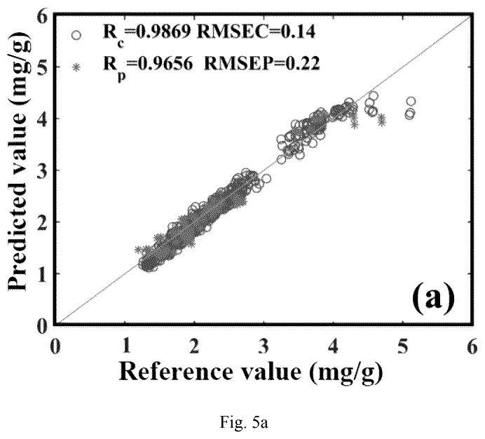

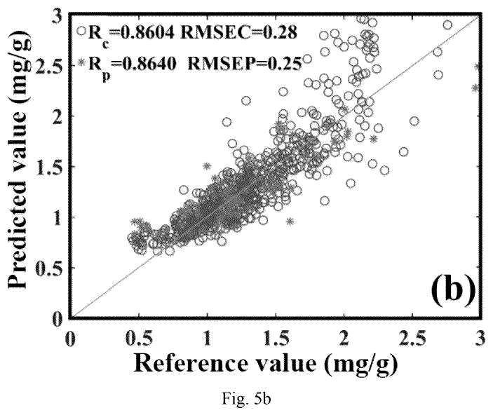

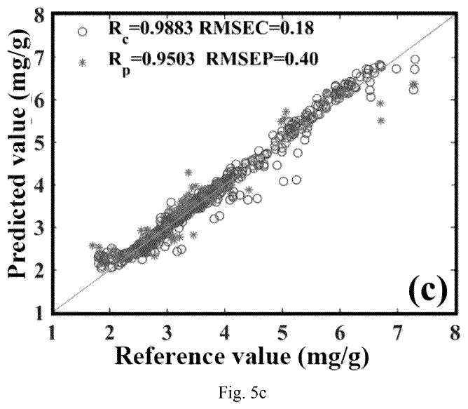

FIGS. 5a-c were scatter plots of chlorophyll a, chlorophyll b, and total chlorophyll contents predicted by the DDA-ResNet model during the tea drying process. The results indicated that the majority of the testing set samples were distributed close to the ideal regression line, and demonstrated that the DDA-ResNet model achieved the high prediction accuracy and stability of chlorophyll a, chlorophyll b, and total chlorophyll contents during the tea drying process. Overall, the effectiveness of the method proposed herein has been verified through the above results.

In embodiments, the present disclosure provides an electronic device, including a memory and a processor. The memory is electrically connected to the processor to achieve communication. The memory is configured to store a program, and the processor is configured to execute the program stored in the memory to implement the aforementioned method.

The present disclosure also provides a non-transitory computer-readable storage medium. A computer program is stored in the non-transitory computer-readable storage medium. The computer program is configured to be executed by a processor to implement the aforementioned method. For example, ROI image of the to-be-detected tea sample are input into the trained DDA-ResNet model to output a quality indicator of the to-be-detected tea sample, to achieve a quality changes monitoring during the tea processing process.

For those of ordinary skill in the art, it should be understood that entire or partial steps of the aforementioned embodiments can be achieved through program-related hardware. The aforementioned program can be stored in the non-transitory computer-readable storage medium. The computer program is configured to be executed by a processor to implement the aforementioned embodiments. The storage medium is selected from the group consisting of read-only memory (ROM), random-access memory (RAM), magnetic disks and optical discs.

It should be noted that the above embodiments are only to illustrate the present disclosure rather than limit this present disclosure. Although the present disclosure has been illustrated in detail with reference to the above embodiments, various modifications and replacements can still be made by those skilled in the art to the features recited in the embodiments. It should be understood that those modifications and replacements made without departing from the spirit and principle of the present disclosure shall fall within the scope of the disclosure defined by the appended claims.

What is claimed is:

1. A method for monitoring quality changes of tea during processing, the method being performed based on a monitoring device;
the monitoring device comprising a conveyor belt and an image acquisition device arranged above the conveyor belt; and the image acquisition device comprising an annular light source, a camera lens, an industrial camera, a camera mounting bracket, a camera position adjustment frame, a sliding rail, a base, a connecting screw rod and a dark box;
the conveyor belt being fixed by a conveyor frame, and passing through the dark box; the base being fixed on a top of the dark box, and being fixedly connected to the sliding rail; and the camera position adjustment frame being movably arranged on the sliding rail via a slider, and being configured to slide along the sliding rail;
the camera lens being arranged on the industrial camera, and the industrial camera being arranged on the camera position adjustment frame via the camera mounting bracket;
the annular light source being arranged below the camera lens, and the conveyor belt being arranged below the annular light source; and the dark box being configured to offer a light-free environment and ensure a consistent image acquisition condition during a tea image acquisition process and
the method comprising:
step (1) rotating a first adjusting knob and a second adjusting knob to adjust a horizontal position of the industrial camera and a horizontal position of the annular light source; adjusting a position of the slider on the sliding rail to ensure the industrial camera to align with the conveyor belt;
collecting H tea samples from a tea processing process, wherein H is a positive integer; placing the H tea samples on the conveyor belt in sequence followed by conveying to the dark box; after the H tea samples enter the dark box, turning on the annular light source, and capturing original images of the H tea samples via the industrial camera;
step (2) delimiting a rectangular region from each of the original images of the H tea samples as a region of interest (ROI); cutting the original images of the H tea samples to obtain ROI images of the H tea samples, respectively; and constructing a tea sample image dataset X based on the ROI images of the H tea samples; and
determining a value Y of a quality indicator of the H tea samples, wherein the quality indicator comprises pigment content;
step (3) training a deformable convolutional attention-enhanced residual network (DDA-ResNet) model with the tea sample image dataset X as input and the quality indicator as output;
wherein the DDA-ResNet model comprises an input layer, a convolutional module, a residual module, a global average pooling layer, a deformable convolutional attention module, a feature fusion module, a fully connected layer and an output layer in sequence;
a size of the input layer is identical to a size of each of the ROI images in the tea sample image dataset X, being 231×231 pixels; the convolutional module is formed by sequential connection of a first convolutional layer with a 7×7 convolution kernel, a first batch normalization layer, a first rectified linear unit (ReLU) activation function layer and a first maximum pooling layer with a pooling size of 3×3;
the residual module is composed of a first residual block, a second residual block and a third residual block connected in sequence; the first residual block, the second residual block and the third residual block have the same structure, and are each composed of a second convolutional layer with a 7×7 convolution kernel, a second batch normalization layer, a second ReLU activation function layer and a second maximum pooling layer with a pooling size of 3×3 connected in sequence;
the deformable convolutional attention module is composed of a first deformable convolutional attention block, a second deformable convolutional attention block and a third deformable convolutional attention block arranged in parallel; the first deformable convolutional attention block, the second deformable convolutional attention block and the third deformable convolutional attention block have the same structure, and are each composed of a deformable convolutional sub-block and an attention sub-block connected in sequence; each of the first deformable convolutional attention block, the second deformable convolutional attention block and the third deformable convolutional attention block is configured to generate a feature map such that a total of three feature maps are generated; the feature fusion module is configured to perform pairwise fusion on the three feature maps generated by the first deformable convolutional attention block, the second deformable convolutional attention block and the third deformable convolutional attention block to form three different feature fusions; the three different feature fusions are configured to be input into the fully connected layer of the DDA-ResNet model, and mapped to the output layer of the DDA-ResNet model; and the output layer has a size of 1×1×1, and is configured to output a predicted value of the quality indicator; and
the DDA-ResNet model is trained through steps of:
(a) initializing network parameters of the DDA-ResNet model, and setting an initial learning rate to η and a maximum number of training iterations to N;
(b) inputting the ROI images in the tea sample image dataset X into the DDA-ResNet model, and calculating the predicted value of the quality indicator by using a forward-propagation algorithm;
(c) calculating a loss value of a loss function L according to formula (I):
$$L = \frac{{\sum }_{i = 1}^{M} {( {\hat{Y}}_{i} - {Y}_{i} )}^{2}}{H} ; \qquad ( I )$$
wherein Ŷᵢ represents a predicted value of the quality indicator of an i-th tea sample, Yᵢ represents a reference value of the quality indicator of the i-th tea sample, and H represents the number of the tea samples in the tea sample image dataset X;
(d) calculating a gradient of the loss function L with respect to the network parameters of the DDA-ResNet model via a back-propagation algorithm;
(e) updating the network parameters of the DDA-ResNet model by using an Adam optimization algorithm according to the gradient; and
(f) repeating steps (b)-(e) until the loss value of the loss function L converges or the maximum number of training iterations Nis reached, a trained DDA-ResNet model is obtained; and
step (4) performing quality monitoring of a to-be-detected sample through steps of:
collecting the to-be-detected tea sample from the tea processing process;
obtaining an ROI image of the to-be-detected tea sample according to steps (1)-(2);
inputting the ROI image of the to-be-detected tea sample into the trained DDA-ResNet model; and
outputting, by the trained DDA-ResNet model, a quality indicator of the to-be-detected tea sample to achieve quality monitoring during the tea processing process.

2. The method according to claim 1, wherein the annular light source is provided with a light-diffusing plate to scatter light beams to ensure uniform illumination on a surface of the to-be-detected tea sample; the annular light source is fixed on the camera mounting bracket via the connecting screw rod, and is located directly below the camera lens; and the annular light source is configured to move synchronously with the industrial camera.

3. The method according to claim 1, wherein the camera position adjustment frame comprises the slider, and the slider is arranged on the sliding rail; a first end of a first lead screw is provided at a first end of the slider, and a first end of a second lead screw is provided at a second end of the slider; a second end of the first lead screw and a second end of the second lead screw are connected to a front fixing bracket, wherein a connecting point between the first lead screw and the front fixing bracket is denoted as A point, and a connecting point between the second lead screw and the front fixing bracket is denoted as B point; a third lead screw and a fourth lead screw are provided on the front fixing bracket from the A point to the B point; the third lead screw is configured to be parallel to the fourth lead screw; the third lead screw and the fourth lead screw are movably connected to the camera mounting bracket; the camera mounting bracket is configured to move from the A point to the B point; the camera mounting bracket is connected to the industrial camera; and a vertical direction of the industrial camera is adjusted by sliding the slider.

4. The method according to claim 3, wherein one of the first end and the second end of the slider is provided with the first adjusting knob; a horizontal movement of the first lead screw and the second lead screw is adjusted by rotating the first adjusting knob, thereby adjusting a horizontal position of the industrial camera; and
the second adjusting knob is provided on an end of the front fixing bracket; and the industrial camera is adjusted to move from the A point to the B point by rotating the second adjusting knob.

5. The method according to claim 1, wherein in step (2), a size of the rectangular region is 231×231 pixels, and His 500-1000.

6. The method according to claim 1, wherein in step (3), a size of a convolution kernel of the first deformable convolutional attention block is 2×2; a size of a convolution kernel of the second deformable convolutional attention block is 4×4; and a size of a convolution kernel of the third deformable convolutional attention block is 6×6.

7. An electronic device, comprising:
a memory; and a processor;
wherein the memory is electrically connected to the processor to achieve communication; the memory is configured to store a program; and the processor is configured to execute the program stored in the memory to implement the method of claim 1.

8. A non-transitory computer-readable storage medium, wherein a computer program is stored in the non-transitory computer-readable storage medium, and the computer program is configured to be executed by a processor to implement the method of claim 1.
